(19) United States
(12) Patent Application Publication
(10) Pub. No.: US 2007/0140913 A1
(43) Pub. Date: Jun. 21, 2007

(54) Rough channel microfluidic devices

(76) Inventors: David S. Cohen, San Bruno, CA (US); Shawn R. Feaster, Duluth, GA (US)

Correspondence Address: KIMBERLY-CLARK WORLDWIDE, INC., 401 NORTH LAKE STREET, NEENAH, WI, 54956, US

(21) Appl. No.: 11/304,159

(22) Filed: Dec. 15, 2005

(51) Int. Cl. B01L 3/02

(52) U.S. Cl. 422/100

(57) ABSTRACT

There is provided a rough microfluidic channel for use, for example, in a lateral flow assay device. The rough microfluidic channel has a roughness greater than a similar channel that is smooth, as measured by a Reynolds number for flow under otherwise identical conditions, which is at least 50 percent greater than the Reynolds number for the smooth channel. Alternatively, the roughness may be greater than a similar channel that is smooth, as measured by the fill time which is at least 25 percent lower for said rough channel than said smooth channel.

### BACKGROUND OF THE INVENTION

Microfluidic devices can be used to obtain a variety of interesting measurements including molecular diffusion coefficients, fluid viscosity, pH, chemical binding coefficients and enzyme reaction kinetics. Other applications for microfluidic devices include capillary electrophoresis, isoelectric focusing, immunoassays, flow cytometry, sample injection of proteins for analysis via mass spectrometry, PCR amplification, DNA analysis, cell manipulation, cell separation, cell patterning and chemical gradient formation. Many of these applications have utility for clinical diagnostics.

A microfluidic device characteristically has one or more channels with at least one dimension less than 1 mm. Common fluids used in microfluidic devices include whole blood samples, bacterial cell suspensions, protein or antibody solutions and various buffers. The use of microfluidic devices to conduct biomedical research and create clinically useful technologies has a number of significant advantages. First, because the volume of fluids within these channels is very small, usually several nanoliters, the amount of reagents and analytes used is also very small. This is especially significant for expensive reagents. The fabrications techniques used to construct microfluidic devices, are relatively inexpensive and are very amenable both to highly elaborate, multiplexed devices and also to mass production. In a manner similar to that for microelectronics, microfluidic technologies enable the fabrication of highly integrated devices for performing several different functions on the same substrate chip. One of the long term goals in the field of microfluidics is to create integrated, portable clinical diagnostic devices for home use, thereby eliminating time consuming laboratory analysis.

In current microfluidic systems, the capillary driven surge flows are affected primarily by the surface energy of the material that comprises the device. Any surface energy variances on the internal walls of the microfluidic channel(s) can result in unpredictable and undesirable fluid flow behavior. This issue can often create unreasonable specifications for manufacturing of microfluidics.

It is an object of this invention to produce microfluidic devices that are less prone to variation in fluid flow behavior due to the surface energy variances on the walls of the microfluidic channels.

### SUMMARY OF THE INVENTION

The inventors have found that if the internal surfaces of a micro-fluidic channel are roughened, the advancing air-liquid interface is presented with a continuously varying and random contact angle, assuming the scale of roughness is small with respect to the dimensions of the channel. This results in a flow behavior that is much less susceptible to variances in the surface energy of the channel walls and is therefore more predictable.

In addition to greater flow surge consistency, microchannels with roughened wall surfaces can provide quicker fill times due to the enhanced wettability of rough surfaces as well as provide increased surface area for particulate or cell capture.

Other features and aspects of the present invention are discussed in greater detail below.

### BRIEF DESCRIPTION OF THE FIGURES

FIG. 1 is a graph of the fill time (y-axis) versus time (x-axis) for matte finish channels and gloss finish channels.

### DETAILED DESCRIPTION

As used herein the term “microfluidic” refers to devices having channels that have one dimension less than 1 mm in size, more particularly they have channels having one dimension in the range of 100 microns or less, and for the detection of viruses, they have channels having one dimension in the range of 10 microns or less.

The flow of a fluid through a microfluidic channel can be characterized by the Reynolds number, defined as Re=LV_{avg}ρ/μ (equation1), where L is the most relevant length scale, μ is the viscosity, ρ is the fluid density, and V_{avg} is the average velocity of the flow. For many microchannels, L is equal to 4A/P where A is the cross sectional area of the channel and P is the wetted perimeter of the channel. Due to the small dimensions of microchannels, the Re is usually much less than 100, often less than 1.0. In this Reynolds number regime, flow is completely laminar and no turbulence occurs. The transition to turbulent flow generally occurs in the range of Reynolds number 2000.

Laminar flow provides a means by which molecules can be transported in a relatively predictable manner through microchannels. Note, however, that at Reynolds numbers below 100, the effect of surface energy variation in the channel walls becomes a proportionately larger issue.

One of the basic laws of fluid mechanics, the no-slip boundary condition, states that the fluid velocity at the walls must be zero. This produces a parabolic velocity profile within the channel. The parabolic velocity profile has significant implications for the distribution of molecules transported within a channel. The disruption of the laminar flow pattern by roughening the surface of the channel does not result in turbulent flow but does disrupt the no-slip condition. This allows fluid to flow through the channel with much less influence or interference from the walls.

Several different techniques have been developed to fabricate microfluidic channels. For, example, hot embossing techniques can be used to imprint patterns into the surface of plastics, or injection molding may be used to create complex structures. Each of the known techniques summarized below has its strengths and weaknesses.

| Material: | Fabrication Technique: |
|---|---|
| Silicon | Chemical wet etch |
| Glass | Chemical etch, laser cutting |
| Polymeric films (e.g., Mylar) | Laminate laser cutting |
| Silicone elastomer (PDMS) | Micromolding (“soft |
| | lithography”) |
| Photoresist, hydrogels, etc. | Photopolymerization |
| | (“microfluidic tectonics”) |
| Thermoplastic | Hot embossing, injection |
| | molding |

Photolithography produces channels etched into, for example, a photosensitive epoxy like SU-8. SU-8 is transparent and inexpensive and allows fabrication of high quality microfluidic channels. The design of microfluidic channels may be done by PC computer modeling using basic CAD programming. These techniques are well known in the art and may be reviewed in, for example, Rapid Tooling Using SU-8 for Injection Molding Microfluidic Components by Edwards et al., published in the proceedings from Proceedings of SPIE Vol. 4177, and Fabrication and Study of Simple and Robust Microfluidic Devices by Hill et al., published in Pharmaceutical Engineering, March/April 2004, Vol, 24, No. 2. The roughening of microfluidic channels is therefore, within the skill of those knowledgeable in the art.

Fabrication consists of laying out the desired fluidic design in a CAD environment, typically, Rhinoceros 3.0 from McNeel North America of Seattle, Wash. This design is cut into the transfer adhesive (e.g.: 3M 467MP with a dual release layer system, 0.002″/50.8 microns thick) using a GraphTech GC3000-40 plotter using a 60 degree cutter. Plotter settings consisted of force at 12, speed at 1 and quality at 1, and no tangential cutting and the 467 MP is placed with the low force release layer (LFRL) on top. These settings are sufficient to cut through the low force release liner and the adhesive, yet it is insufficient to cut through the high force release layer (HFRL). The LFRL covering the undesired adhesive is carefully removed. The exposed adhesive is removed by bonding it to a piece of paper using a Modulam 130 (speed 1, no heat) laminator. The paper is then peeled away taking with it the undesired adhesive. The channels are inspected to ensure that all adhesive has been removed. If excess adhesive is present, it is weeded from the fluidic fields. (The aforementioned process is known in the sign making industry as weeding.) Next, 3M Scotch brand tape is applied as a continuous strip to the remaining LFRL, followed by lamination. The tape is subsequently removed taking the remaining LFRL away also. The newly exposed adhesive is capped with one piece of planar sheet stock followed by cold lamination. The HFRL is removed as described for the LFRL leaving the transfer adhesive bound to the sheet stock. Next, a second piece of sheet stock is applied to the adhesive followed by cold lamination. The result is a set of ganged fluidic devices. Note that both pieces of sheet stock need not be identical in composition.

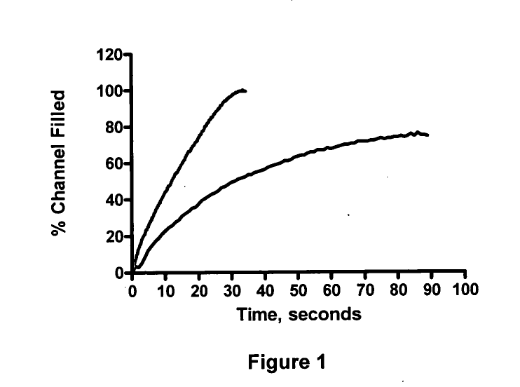

To assess the influence of a rough surface versus a smooth surface on flow dynamics, a series of fluidic devices was constructed. In this series of devices, the channels were 2.5 millimeters wide and twenty millimeters long. At the proximal end of the channels a circular well was constructed to provide a consistent sample application zone. These channels were ganged together then cut into 3M 467MP transfer adhesive as described above. The adhesive was laminated between two pieces of Hurculene matte finish drafting film (191153 Lot F135231124). It should be noted that this film possesses one side with a matte finish while the other side has a glossy appearance. Two separate ganged systems were constructed with this film. In one instance, the matte surface finish was placed face down onto the exposed adhesive. The glossy surface was placed face down onto another set of adhesive channels. Next, a fluidic system was placed under a Logitech QuickCam Zoom web camera. The camera was set to collect thirty frames a second at 320×240 pixel resolution. Video collection was initiated followed by a 1.5 microliter aliquot of blood. Video collection proceeded until flow terminated. This process was repeated in duplicate for 1.5, 2.0, 2.5, and 2.75 microliters of blood for both types of fluidic channels. Each video was processed using software such that channel fill was determined as a function of time. This data was fit using non-linear least squares analysis within GraphPad Prism 4.0 to a simple exponential equation and is shown in FIG. 1. Secondary plots of percent channel filled vs. applied volume and observed first order rate constant vs. applied volume were also constructed. In FIG. 1 time in seconds from 0 to 100 is on the X-axis and percent channel fill from 0 to 120 is on the Y-axis. The higher line corresponds to the matte finish and the lower line corresponds to the gloss finish. The R² value for all fits was greater than 0.98. As can be seen in FIG. 1, the rougher, matte finish channels filled much more quickly than the smoother, gloss finish channels.

Surface roughness was determined using a MicroPhotonics TR2000 roughness gauge for both surfaces of the drafting film. The matte side possessed an average roughness of 1.045 micrometers while the glossy side was 0.439 micrometers. Average roughness is the average deviation of the profile from a mean line or it is the average distance from the profile to mean line over the length of the assessment. This parameter is automatically calculated from the data collected by the TR2000. Contact angle measurements were obtained by adhering a small portion of the drafting film to a glass slide with double-sided adhesive tape. One microliter of the blood was applied to the substrate held in place by the tape and the contact angle was measured. The following results were obtained.

| | Contact Angle (°) | | | | | Average |
|---|---|---|---|---|---|---|
| Matte | 47.4 | 48.6 | 47.0 | 49.1 | 50.7 | 48.6 ± 1.5 |
| Side | | | | | | |
| Gloss | 51.0 | 51.4 | 49.8 | 47.3 | 46.7 | 49.2 ± 2.1 |
| Side | | | | | | |

The data clearly demonstrate that surface roughness plays a significant role in fluid migration within microchannels. Also, the fluid front within the rough channel system was much better defined, which suggests that surface roughness aides in averaging out /eliminating localized surface area inconsistencies.

While roughening techniques for microfluidic channels are within the skill of those knowledgeable in the art, the inventors are unaware of it having been practiced previously. In fact, the conventional wisdom has been to prefer smooth channels in the belief that laminar flow would be more efficient and produce a better result.

The quantification of the “roughness” of a microfluidic channel is a somewhat daunting task since it is a relative measure. It may, however, be characterized by the increase in the Reynolds number for flow through two similar channels, one rough and one smooth, under otherwise identical conditions. The inventors believe that an increase in Reynolds number of at least 50 percent and more particularly more than 100 percent is necessary to experience the beneficial effects of the invention. Alternatively, the fill time of a microfluidic channel may be measured, with the rough channel having a much lower fill time than the smooth channel, under otherwise identical conditions. The fill time for the rough channel should be at least 25 percent less and more particularly more than 50 percent less than the smooth channel.

Another advantage to the instant invention is that an increase in surface area due to the increased roughness allows for an increase in area that can be used for “capture” of analytes or contaminates. For example, by treating the area with a reagent designed to selectively bind red blood cells (RBC) such as an antibody or lectin or the like, more red blood cells can be removed from the sample. Generally speaking, due to the small size of the channels and the amount of RBCs typically found in blood, the limited surface area in conventional microfluidic channels is insufficient to fully capture the RBC's in a small flow path. By increasing the roughness and hence the surface area, more RBC can be captured which allows for smaller flow paths.

One particular use for roughened microfluidic channels is in flow-through or lateral-flow assays, which have become more common for many analytes. These assays detect the presence or quantity of an analyte residing in a test sample. These devices work on the principal of capillary flow of a mobile phase like a bodily fluid, through a microfluidic channel. Interference from the walls of the channels may be minimized by the roughening of the walls as taught herein.

As used herein, the term “analyte” generally refers to a substance to be detected in a test sample. The test sample may be derived from a biological source, such as a physiological fluid, including, blood, interstitial fluid, saliva, ocular lens fluid, cerebral spinal fluid, sweat, urine, milk, ascites fluid, mucous, synovial fluid, peritoneal fluid, vaginal fluid, amniotic fluid or the like. Besides physiological fluids, other liquid samples may be used, such as water, food products, and so forth. In addition, a solid material suspected of containing the analyte may also be used as the test sample. Analytes may include antigenic substances, haptens, antibodies, and combinations thereof. Analytes include, but are not limited to, toxins, organic compounds, proteins, peptides, microorganisms, amino acids, nucleic acids, hormones, steroids, vitamins, drugs (including those administered for therapeutic purposes as well as those administered for illicit purposes), drug intermediaries or byproducts, bacteria, virus particles, yeasts, fungi, protozoa, and metabolites of or antibodies to any of the above substances. Specific examples of some analytes include ferritin; creatinine kinase MB (CK-MB); digoxin; phenytoin; phenobarbitol; carbamazepine; vancomycin; gentamycin; theophylline; valproic acid; quinidine; luteinizing hormone (LH); follicle stimulating hormone (FSH); estradiol, progesterone; C-reactive protein; lipocalins; IgE antibodies; cytokines; vitamin B2 micro-globulin; glycated hemoglobin (Gly. Hb); cortisol; digitoxin; N-acetylprocainamide (NAPA); procainamide; antibodies to rubella, such as rubella-IgG and rubella IgM; antibodies to toxoplasmosis, such as toxoplasmosis IgG (Toxo-IgG) and toxoplasmosis IgM (Toxo-IgM); testosterone; salicylates; acetaminophen; hepatitis B virus surface antigen (HBsAg); antibodies to hepatitis B core antigen, such as anti-hepatitis B core antigen IgG and IgM (Anti-HBC); human immune deficiency virus 1 and 2 (HIV 1 and 2); human T-cell leukemia virus 1 and 2 (HTLV); hepatitis B e antigen (HBeAg); antibodies to hepatitis B e antigen (Anti-HBe); influenza virus; thyroid stimulating hormone (TSH); thyroxine (T4); total triiodothyronine (Total T3); free triiodothyronine (Free T3); carcinoembryoic antigen (CEA); lipoproteins, cholesterol, and triglycerides; and alpha fetoprotein (AFP). Drugs of abuse and controlled substances include, but are not intended to be limited to, amphetamine; methamphetamine; barbiturates, such as amobarbital, secobarbital, pentobarbital, phenobarbital, and barbital; benzodiazepines, such as librium and valium; cannabinoids, such as hashish and marijuana; cocaine; fentanyl; LSD; methaqualone; opiates, such as heroin, morphine, codeine, hydromorphone, hydrocodone, methadone, oxycodone, oxymorphone and opium; phencyclidine; and propoxyhene. Other potential analytes may be described in U.S. Pat. No. 6,436,651.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A microfluidic channel having a roughness greater than a similar channel that is smooth, as measured by a Reynolds number for flow under otherwise identical conditions, which is at least 50 percent greater than a Reynolds number for said smooth channel.

2. The microfluidic channel of claim 1 wherein said Reynolds number is at least 100 percent greater than said Reynolds number for said smooth channel.

3. The microfluidic channel of claim 1 wherein said channel has at least one dimension less than 1 mm.

4. The microfluidic channel of claim 1 wherein said channel has at least one dimension less than 100 microns.

5. The microfluidic channel of claim 1 wherein said channel has at least one dimension less than 10 microns.

6. A rough microfluidic channel having a roughness greater than a similar channel that is smooth, as measured by a fill time which is at least 25 percent lower for said rough channel than said smooth channel.

7. The channel of claim 6 wherein said fill time is at least 50 percent lower for said rough channel than said smooth channel.

8. The microfluidic channel of claim 6 wherein said channel has at least one dimension less than 1 mm.

9. The microfluidic channel of claim 6 wherein said channel has at least one dimension less than 100 microns.

10. The microfluidic channel of claim 1 wherein said channel has at least one dimension less than 10 microns.

11. A lateral flow assay device for detecting the presence or quantity of an analyte residing in a test sample, said lateral flow assay device comprising a microfluidic channel having a roughness at least 50 percent greater than a similar channel that is smooth, as measured by a Reynolds number for flow under otherwise identical conditions.

12. The lateral flow assay device of claim 11 wherein the test sample is obtained from vaginal fluid.

13. The lateral flow assay device of claim 11 wherein the test sample is obtained from a wound exudate.

14. The lateral flow assay device of claim 11 wherein the test sample is obtained from blood.
